(19) United States
(12) Patent Application Publication
(10) Pub. No.: US 2025/0363717 A1
(43) Pub. Date: Nov. 27, 2025

(54) CLOSEST SILHOUETTE QUERIES FOR RAY TRAVERSAL

(71) Applicant: NVIDIA Corporation, Santa Clara, CA (US)

(72) Inventors: Nathan Morrical, Seattle, WA (US); Sai Bangaru, Cambridge, MA (US); Lifan Wu, Kirkland, WA (US); Rohan Sawhney, Palo Alto, CA (US); Shuang Zhao, Irvine, CA (US); Ravi Ramamoorthi, Carlsbad, CA (US); Markus Kettunen, Uusimaa (FI); Christopher Ryan Wyman, Redmond, WA (US)

(21) Appl. No.: 19/094,441

(22) Filed: Mar. 28, 2025

Related U.S. Application Data
(60) Provisional application No. 63/651,329, filed on May 23, 2024.

(51) Int. Cl. G06T 15/06

(52) U.S. Cl. CPC G06T 15/06

(57) ABSTRACT

Inverse rendering is important for training neural networks for generative artificial intelligence (AI), and it involves inverting the rendering process by taking an image and converting it into scene or model parameters that can be backpropagated through a network, helping to train the network to learn to generate models, materials, textures, etc. Because of the gradients required for this backpropagation, inverse rendering requires differentiable rendering algorithms. Current differentiable renderers are based on rasterization which make it difficult to learn scene properties depending on second order effects. The present disclosure provides closest silhouette queries for computing differential visibility, which can be used for inverse rendering.

### RELATED APPLICATION(S)

This application claims the benefit of U.S. Provisional Application No. 63/651,329 (Attorney Docket No. NVIDP1405+/24-RE-0598US01) titled “CLOSEST SILHOUETTE QUERIES FOR ESTIMATING DIFFERENTIABLE VISIBILITY,” filed May 23, 2024, the entire contents of which is incorporated herein by reference.

### TECHNICAL FIELD

The present disclosure relates to techniques for computing differential visibility.

### BACKGROUND

Inverse rendering is important for training neural networks for generative artificial intelligence (AI). It allows inverting the rendering process, taking an image and converting it into scene or model parameters that can be backpropagated through a network, helping to train the network to learn to generate models, materials, textures, etc. Because of the gradients required for this backpropagation, inverse rendering actually requires differentiable rendering algorithms.

Today's widely used differentiable renderers are based on rasterization, which means training is less than optimal. This is because with raster-based renderers it is hard to learn scene properties depending on second order effects (e.g. shadows, interreflections, glossy reflections, global illumination, etc.). To learn these properties, a differentiable ray or path tracer is needed. This requires being able to differentiate all parts of a ray tracer, including the key component: the visibility query.

There are a number of existing techniques to approximate or compute differentiable visibility, including “warped-area sampling” and “path-space differentiable rendering” (PSDR). Warped area sampling approximates visibility gradients with a Monte Carlo sampling process. This requires lots of rays (up to 32+ per query), is biased (so it may produce incorrect results and unexpected training behaviors), and gives quite noisy gradients (which may slow training times). Techniques like PSDR re-parameterize the mathematical representation of the scene, allowing more exact computations but necessitating a new, complex data structure that is relatively costly to build, update, and query.

There is thus a need for addressing these issues and/or other issues associated with the prior art. For example, there is a need to provide closest silhouette queries for computing differential visibility, which can be used for inverse rendering.

### SUMMARY

A method, computer readable medium, and system are disclosed for computing differential visibility. An initialized cone representative of a region of a scene is generated, wherein the initialized cone is defined by a central ray and an initialized angle from the central ray. The central ray is traced to determine visibility information for the central ray. Based on the visibility information for the central ray, a closest silhouette boundary to the central ray by angle is detected. An indication of the central ray and an angle of the closest silhouette boundary to the central ray is output as parameters of a continuous visibility gradient.

### BRIEF DESCRIPTION OF THE DRAWINGS

FIG. 1 illustrates a method for computing differential visibility, in accordance with an embodiment.

FIG. 2 illustrates a visualization of a closest silhouette query, in accordance with an embodiment.

FIGS. 3A-B illustrate visualizations of silhouette boundaries, in accordance with an embodiment.

FIG. 4A illustrates a visualization of using differential visibility to cull an invisible silhouette, in accordance with an embodiment.

FIG. 4B illustrates a visualization of using differential visibility to provide an instance transform with non-uniform scale, in accordance with an embodiment.

FIG. 5 illustrates a method for using a closest silhouette query for forward rendering, in accordance with an embodiment.

FIG. 6 illustrates a method for training a generative model from a given scene a differentiable visibility computed for the given scene, in accordance with an embodiment.

FIG. 7 illustrates an exemplary computing system, in accordance with an embodiment.

### DETAILED DESCRIPTION

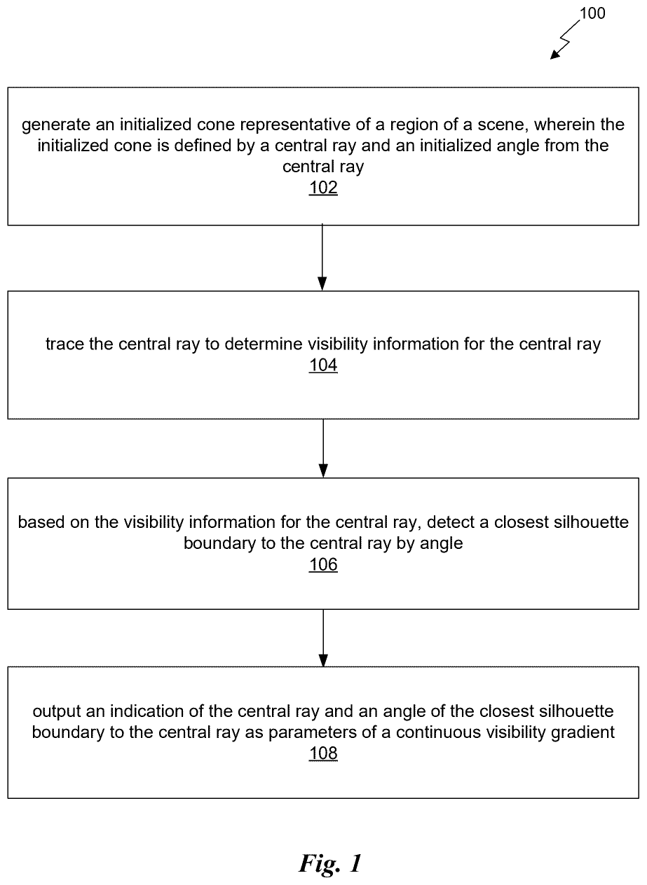

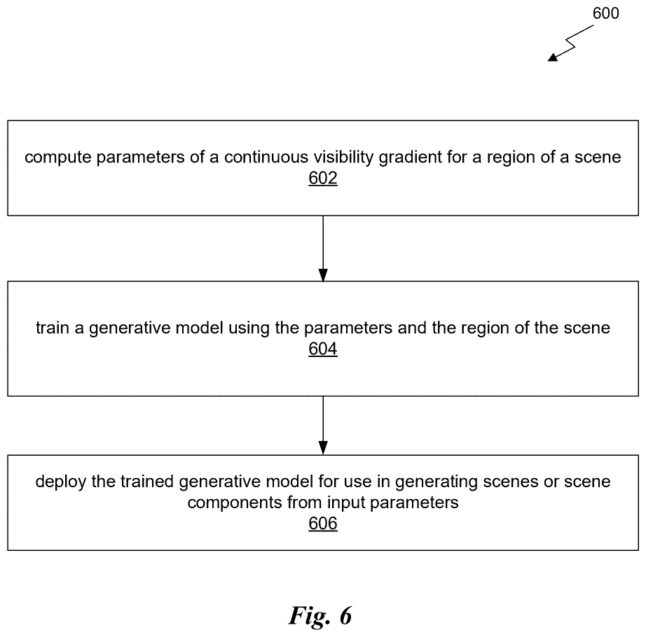

FIG. 1 illustrates a method 100 for providing differential visibility, in accordance with an embodiment. The method 100 may be performed by any device that includes a processing unit, a program, custom circuitry, and/or any combination of the same. For example, the method 100 may be executed by a GPU (graphics processing unit), CPU (central processing unit), or any processor capable of image processing. As another example, the method 100 may be performed by the computing system of FIG. 6. Furthermore, persons of ordinary skill in the art will understand that any system that performs the method 100 is within the scope and spirit of embodiments of the present disclosure.

With respect to the present disclosure, differential visibility refers to the differentiable (e.g. continuous) visibility of a surface in a scene. As disclosed below, the differential visibility for a region of a scene can be computed using a closest silhouette query, which returns a closest visibility discontinuity with respect to a surface intersected by a given ray. The closest silhouette query allows for efficient approximation or computation of continuous (non-noisy) visibility gradients, which as disclosed herein may be achieved while using a data structure very similar to the existing bounding volume hierarchies used in modern ray tracers. While the method 100 computes differential visibility with respect to a particular region of a scene, it should be noted that the method 100 may be repeated for all regions in the scene or for a portion thereof.

In operation 102, an initialized cone representative of a region of a scene is generated, wherein the initialized cone is defined by a central ray and an initialized angle from the central ray. The scene may be represented as a grid of pixels or other visual information. The region of the scene may refer to any portion of the scene. For example, the region of the scene may be a sub-block of pixels within the scene.

The vertex, or apex, of the initialized cone may be defined by the origin point of the central ray. The radius of the base of the cone may be defined by the initialized angle from the central ray. In an embodiment, the initialized angle may be predefined.

In operation 104, the central ray is traced to determine visibility information for the central ray. In an embodiment, the visibility information may indicate a visible geometry. For example, the ray may be traced until an intersection with a surface in the scene is detected.

In an embodiment, the central ray may be traced using a bounding volume hierarchy generated for the scene. In an embodiment, the central ray may be traced by traversing the bounding volume hierarchy in a depth-first order. In an embodiment, the traversal of the bounding volume hierarchy may prioritize bounding volumes with a smallest angular distance with respect to the initialized cone.

In operation 106, based on the visibility information for the central ray, a closest silhouette boundary to the central ray by angle is detected. The silhouette boundary refers to a point at which the visibility changes. For example, the silhouette boundary may be a point at which the visible geometry, or surface, is no longer visible (e.g. due to occlusion, etc.) in the scene. In an embodiment, the closest silhouette boundary may be a virtual silhouette boundary introduced by non-manifold self-intersections between interpenetrating triangles.

As mentioned, the silhouette boundary that is closest to the central ray in terms of angle is detected. In other words, a silhouette boundary with a smallest angle to the central ray is determined. In an embodiment, the closest silhouette boundary may be detected by reducing the initialized angle over one or more steps. At each step, a second ray emitted from the vertex of the cone and with the reduced angle to the central ray may be traced.

In another embodiment, the closest silhouette boundary may be detected by traversing a bounding volume hierarchy generated for the scene. In this embodiment, the bounding volume hierarchy may include a minimal angle from the central ray to each of a plurality of bounding volumes in the bounding volume hierarchy. Thus, the bounding volume hierarchy may be augmented to include the angle information per bounding volume.

In an embodiment, the closest silhouette boundary may be detected by traversing the bounding volume hierarchy in a depth-first order by angle. In an embodiment, during the traversal, a subtree within the bounding volume hierarchy may be culled when the minimal angle for a bounding volume represented by the subtree is larger than an angle of a latest detected closest silhouette boundary to the central ray. In an embodiment, during the traversal, only a subset of all edges of a bounding volume may be tested. In an embodiment, a geometric normal of a surface intersected by the central ray may be used as a clipping plane for the traversal. In an embodiment, the closest silhouette boundary may be detected using a single query, for example according to the embodiments described above.

In an embodiment, at most six edges and at least one edge may need be tested. In an embodiment, the exact number of edges required for testing may depend on a maximum allowable initial cone angle, what (if any) of the faces of the bounding volume occlude the other faces, and if any of the scalar extents of the bounding volume degenerate to zero length. For cones with a maximum angle of 90 degrees, only one of two axis aligned edges may need to be tested. When the cone angle exceeds 90 degrees, both edges in a given axis aligned pair may need to be tested. In the case that one of the bounding volume's faces occludes the other 5 faces for bounding volume with 6 faces, the silhouette of the bounding volume may consist of two pairs of axis aligned edges (4 total, defining a visible rectangle), where only 2 need to be tested for cones with a maximum initial angle of 90 degrees. If two of the dimensions of the bounding volume degenerate to zero, then only a single edge of the bounding volume may need to be tested. This can occur for axis aligned line segments. In the general case where the initial cone angle might exceed 90 degrees, at most three faces of the bounding volume can be visible, resulting in a silhouette of at most 3 pairs of axis aligned edges (which is 6 edges total).

In another embodiment, the closest silhouette boundary may be detected using multiple queries. For example, from the initialized cone, 1 to N iterations may be performed which include: (1) selecting a point on the circular perimeter of the current cone using a random number generator; (2) using the randomly selected point, constructing a new central ray with a same origin as the initial central ray but with a direction pointing to the randomly selected point; (3) computing the closest silhouette point with respect to this newly constructed central ray direction; and (4) constructing a new cone, using the central axis generated from (2) and the angle found in (3); returning to step (1) for a next iteration based on the new cone. The iterations may provide a random “walk on cones” or “walk on spherical caps” procedure. After the N steps, the final silhouette point may be used to define an estimate of a “visibility gradient” as mentioned below, whose degree of continuity increases with N. Such random walks may be performed, taking a running average of these visibility gradient estimates, and converging the results up to a predefined limit. Higher sample counts may give more accurate estimates, while lower sample counts may reduce computation time.

In operation 108, an indication of the central ray and an angle of the closest silhouette boundary to the central ray is output as parameters of a continuous visibility gradient. In an embodiment, the central ray and the angle of the closest silhouette boundary to the central ray may define a cone-shaped region in the scene having no visibility changes to the visibility information. In an embodiment, the central ray and the angle of the closest silhouette boundary to the central ray may define a cone-shaped region in the scene having no ray-geometry intersections.

To this end, the method 100 may define a closest silhouette query that determines a central ray and an angle of the closest silhouette boundary to the central ray. Thus, the closest silhouette boundary is determined by angle to the central ray rather than Euclidean distance. The central ray and angle together define a region of assured, or continuous, visibility. For example, because conical region returned by the method 100 is empty, or void of obstacles, it can be used to accelerate ray tracing. One or more rays originating at the cone's vertex or inside the cone can safely skip to the end of the cone, or to the surface of the cone, without having to use the ray tracing unit to trace the ray within that conical region, thereby providing accelerated ray tracing. This acceleration can be used for both forward and inverse rendering.

In an embodiment, the method 100 may be an inverse rendering method, in particular that generates the continuous visibility gradient parameters for the given region of the scene. In an embodiment, the parameters may be output for providing differentiable visibility. In an embodiment, the parameters may define boundaries of a region adjacent to a visibility discontinuity in the scene. In an embodiment, in the region a new corrective term may be added to account for a missing visibility gradient. In an embodiment, the gradient may be linearly ramped to give a constant divergence field and lower variance.

In an embodiment, the central ray and the angle of the closest silhouette boundary to the central ray defines a cone-shaped region that provides an area of known support for integrating. For example, in the present embodiment a cone can be defined via the central ray (e.g. whose ray origin defines the “apex” of the cone, and whose ray direction defines the “central axis” of the cone) and a half angle to the lateral surface of the cone where the half angle is defined by the angular measure between the central ray direction and the direction from the central ray origin to the closest silhouette point. In this context, the area of known support for integrating may refer to the base area of the cone. In an embodiment, an interpolation of the originally discontinuous values may be performed along the silhouette edges of the geometry, blending and interpolating these values into the interior non-silhouette regions. By creating this smooth blending with respect to the cone angle, how fast that gradation changes can be computed, which in turn allows for computation of the gradient of visibility.

In another embodiment, the parameters may be output for forward rendering. In general, rendering operates in spherical domains, such that when an image is being rendered the rays are traced in a solid angle conic. Thus, the parameters, as defined by the central ray and the angle, may be effectively used during rendering. In an embodiment, the closest silhouette boundary may indicate a closest point on an occluding shadow edge which is used during the forward rendering to approximate a soft shadow. In an embodiment, the closest silhouette boundary may be used to determine which neighbors can be reused at minimal cost during the forward rendering.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

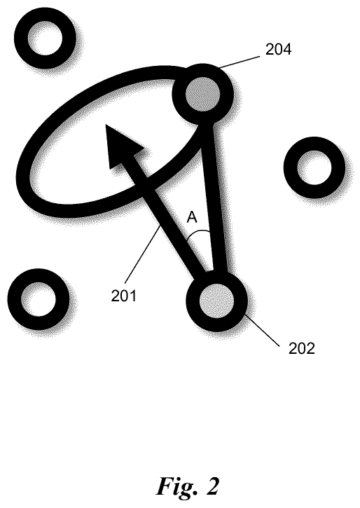

FIG. 2 illustrates a visualization of a closest silhouette query, in accordance with an embodiment. The closest silhouette query may be performed, for example via the method 100 of FIG. 1, to return parameters of a continuous visibility gradient for a region in a scene.

As shown, a cone-shaped region in a scene having no visibility changes to visibility information is estimated. The cone-shaped region, or “cone”, is defined by a central ray 201 originating at a point 202 representing an apex of the cone and an angle A of the closest silhouette boundary 204 to the central ray 201. The central ray 201 and the angle A may be provided as parameters of a continuous visibility gradient for the region of the scene.

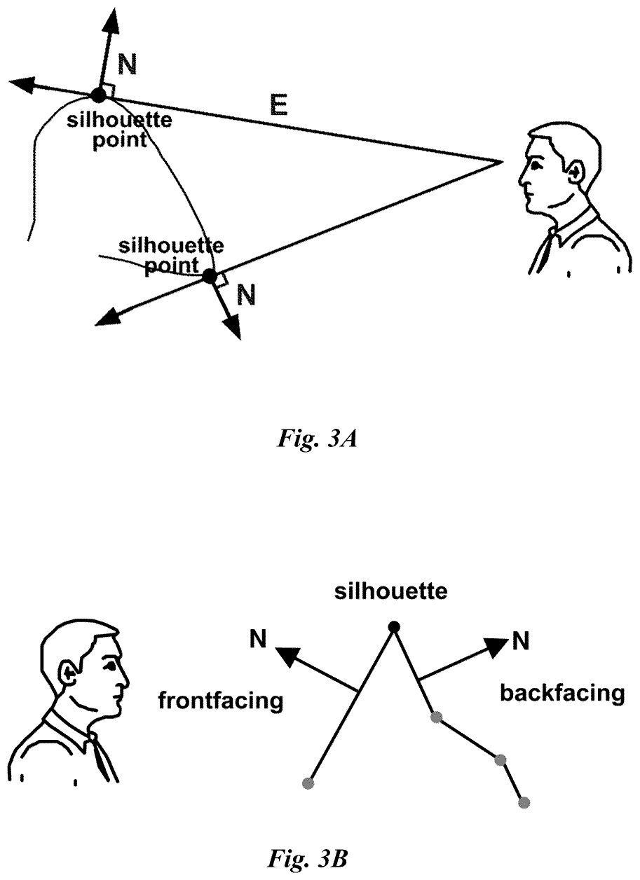

FIGS. 3A-B illustrate visualizations of silhouette boundaries, in accordance with an embodiment. Assuming a smooth surface, FIG. 3A illustrates that, with respect to a given viewpoint (shown as eye E, but can refer to a camera viewpoint), a silhouette point exists where E dotted with the surface normal is exactly 90 degrees, or perpendicular. FIG. 3B illustrates that the silhouette set for a polygonal model is defined to be all edges in the model which are shared by both a front-facing and back-facing polygon.

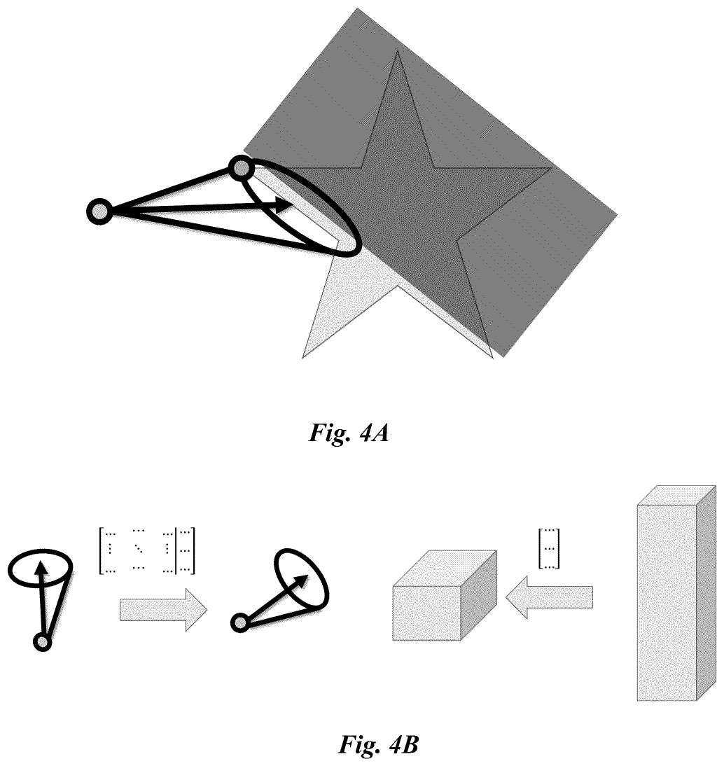

FIG. 4A illustrates a visualization of using differential visibility to cull an invisible silhouette, in accordance with an embodiment. The invisible silhouette refers to a silhouette of a geometry in a scene, including its boundary, that is not visible from a current viewpoint. For example, the silhouette may be occluded by another geometry in the scene.

With respect to the present embodiment, the differential visibility is computed per the method 100 of FIG. 1. In the example shown, the invisible silhouette of the star-shaped geometry is the portion not covered by the rectangular shape. To cull the invisible silhouette, the intersected surface's geometric normal may be used as a clipping plane. This solution is not only inexpensive computation-wise but is also exact for planar objects.

FIG. 4B illustrates a visualization of using differential visibility to provide an instance transform with non-uniform scale, in accordance with an embodiment. The instance transform refers to a change in the position, rotation, or scale of a geometry in a scene.

With respect to the present embodiment, the differential visibility is computed per the method 100 of FIG. 1. In the present embodiment, transforms may be decomposed into rigid and non-rigid components. Inverse rigid transforms may then be applied to the ray, and non-uniform scales may be forwarded to the primitives.

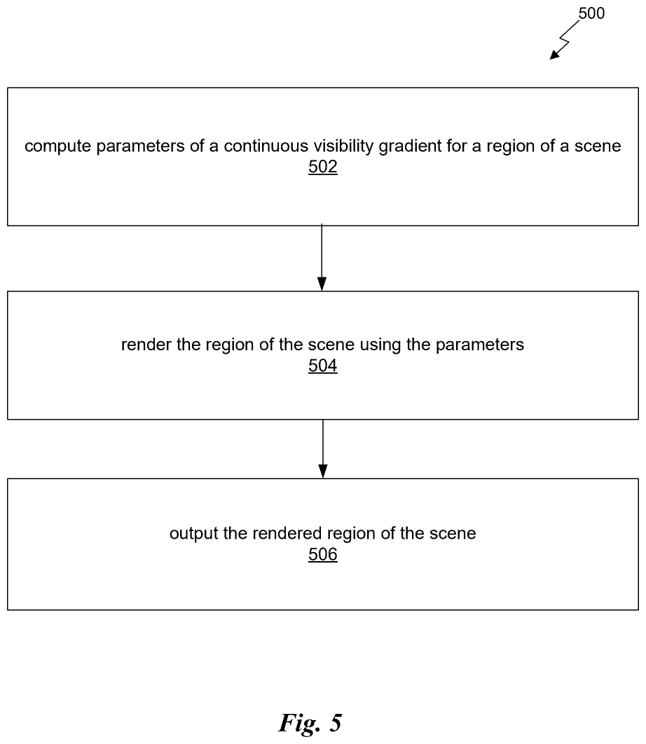

FIG. 5 illustrates a method 500 for using a closest silhouette query for forward rendering, in accordance with an embodiment. In operation 502, parameters of a continuous visibility gradient are computed for a region of scene. The parameters may be computed in accordance with the method 100 of FIG. 1.

In operation 504, the region of the scene is rendered using the parameters. The region of the scene may also be rendered using additional parameters defining the region of the scene, such as a color, texture, etc. of the region. In operation 506, the rendered region of the scene is output. For example, the rendered region of the scene may be displayed as an image, stored to a memory, transmitted over a network to a remote device, etc.

FIG. 6 illustrates a method 600 for training a generative model from a given scene a differentiable visibility computed for the given scene, in accordance with an embodiment. In operation 602, parameters of a continuous visibility gradient are computed for a region of scene. The parameters may be computed in accordance with the method 100 of FIG. 1.

In operation 604, a generative model is trained using the parameters and the region of the scene. The generative model may also be trained using additional parameters defining the region of the scene, such as a color, texture, etc. of the region. For example, supervised learning may be used to train the generative model to generate the region of the scene from the parameters, with using the given region of the scene as a ground truth.

In operation 606, the trained generative model is deployed for use in generating scenes or scene components from input parameters. For example, a downstream application may use the trained generative model to generate a scene or scene component from the input parameters.

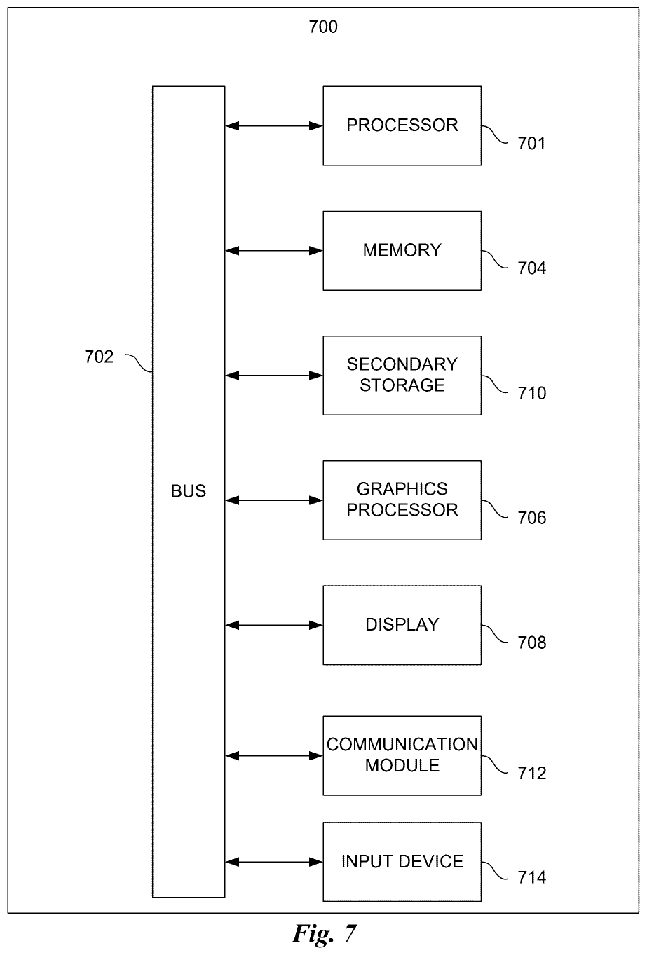

FIG. 7 illustrates an exemplary computing system 700, in accordance with an embodiment. The exemplary computing system 700 may be implemented to carry out any of the methods described herein. For example, the exemplary computing system 700 may perform the closest silhouette queries described above, and in some embodiments may also perform the image rendering using such queries as described above.

As shown, the system 700 includes at least one central processor 701 which is connected to a communication bus 702. The system 700 also includes main memory 704 [e.g. random access memory (RAM), etc.]. The system 700 also includes a graphics processor 706. In some embodiments, the system 700 includes a display 708.

The system 700 may also include a secondary storage 710. The secondary storage 710 includes, for example, a hard disk drive and/or a removable storage drive, representing a floppy disk drive, a magnetic tape drive, a compact disk drive, a flash drive or other flash storage, etc. The removable storage drive reads from and/or writes to a removable storage unit in a well-known manner.

Computer programs, or computer control logic algorithms, may be stored in the main memory 704, the secondary storage 710, and/or any other memory, for that matter. Such computer programs, when executed, enable the system 700 to perform various functions, including for example performing closest silhouette queries and/or rendering based on such queries. Memory 704, storage 710 and/or any other storage are possible examples of non-transitory computer-readable media.

The system 700 may also include one or more communication modules 712. The communication module 712 may be operable to facilitate communication between the system 700 and one or more networks, and/or with one or more devices (e.g. game consoles, personal computers, servers etc.) through a variety of possible standard or proprietary wired or wireless communication protocols (e.g. via Bluetooth, Near Field Communication (NFC), Cellular communication, etc.).

As also shown, in some embodiments the system 700 may include one or more input devices 714. The input devices 714 may be a wired or wireless input device. In various embodiments, each input device 714 may include a keyboard, touch pad, touch screen, game controller, remote controller, or any other device capable of being used by a user to provide input to the system 700.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
at a device:
generating an initialized cone representative of a region of a scene, wherein the initialized cone is defined by a central ray and an initialized angle from the central ray;
tracing the central ray to determine visibility information for the central ray;
based on the visibility information for the central ray, detecting a closest silhouette boundary to the central ray by angle; and
outputting an indication of the central ray and an angle of the closest silhouette boundary to the central ray as parameters of a continuous visibility gradient.

2. The method of claim 1, wherein the initialized angle is predefined.

3. The method of claim 1, wherein the visibility information indicates a visible geometry.

4. The method of claim 1, wherein the central ray is traced using a bounding volume hierarchy generated for the scene.

5. The method of claim 4, wherein the central ray is traced by traversing the bounding volume hierarchy in a depth-first order prioritizing bounding volumes with a smallest angular distance with respect to the initialized cone.

6. The method of claim 1, wherein the closest silhouette boundary is detected by reducing the initialized angle over one or more steps.

7. The method of claim 1, wherein the closest silhouette boundary is detected by traversing a bounding volume hierarchy generated for the scene.

8. The method of claim 7, wherein the bounding volume hierarchy includes a minimal angle from the central ray to each of a plurality of bounding volumes in the bounding volume hierarchy.

9. The method of claim 7, wherein the closest silhouette boundary is detected by traversing the bounding volume hierarchy in a depth-first order by angle.

10. The method of claim 9, wherein during the traversal, a subtree within the bounding volume hierarchy is culled when the minimal angle for a bounding volume represented by the subtree is larger than an angle of a latest detected closest silhouette boundary to the central ray.

11. The method of claim 9, wherein during the traversal, only a subset of all edges of a bounding volume are tested.

12. The method of claim 11, wherein between 1 and 6 edges of the bounding volume are tested.

13. The method of claim 9, wherein a geometric normal of a surface intersected by the central ray is used as a clipping plane for the traversal.

14. The method of claim 1, wherein the closest silhouette boundary is detected using a single query.

15. The method of claim 1, wherein the closest silhouette boundary is detected using multiple queries.

16. The method of claim 1, wherein the closest silhouette boundary is a virtual silhouette boundary introduced by non-manifold self-intersections between interpenetrating triangles.

17. The method of claim 1, wherein the central ray and the angle of the closest silhouette boundary to the central ray defines a cone-shaped region in the scene having no visibility changes to the visibility information.

18. The method of claim 1, wherein the central ray and the angle of the closest silhouette boundary to the central ray defines a cone-shaped region in the scene having no ray-geometry intersections.

19. The method of claim 1, wherein the method is an inverse rendering method.

20. The method of claim 1, wherein the parameters are output for providing differentiable visibility.

21. The method of claim 20, wherein the parameters define boundaries of a region adjacent to a visibility discontinuity in the scene.

22. The method of claim 21, wherein in the region a new corrective term is added to account for a missing visibility gradient.

23. The method of claim 22, wherein the gradient is linearly ramped to give a constant divergence field and lower variance.

24. The method of claim 20, wherein the central ray and the angle of the closest silhouette boundary to the central ray defines a cone-shaped region that provides an area of known support for integrating.

25. The method of claim 1, wherein the parameters are output for forward rendering.

26. The method of claim 25, wherein the closest silhouette boundary indicates a closest point on an occluding shadow edge which is used during the forward rendering to approximate a soft shadow.

27. The method of claim 25, wherein the closest silhouette boundary is used to determine which neighbors can be reused at minimal cost during the forward rendering.

28. A system, comprising:
a non-transitory memory storage comprising instructions; and
one or more processors in communication with the memory, wherein the one or more processors execute the instructions to:
generate an initialized cone representative of a region of a scene, wherein the initialized cone is defined by a central ray and an initialized angle from the central ray;
trace the central ray to determine visibility information for the central ray;
based on the visibility information for the central ray, detect a closest silhouette boundary to the central ray by angle; and
output an indication of the central ray and an angle of the closest silhouette boundary to the central ray as parameters of a continuous visibility gradient.

29. The system of claim 28, wherein the parameters are output for forward rendering.

30. The method of claim 29, wherein the closest silhouette boundary indicates a closet point on an occluding shadow edge which is used during the forward rendering to approximate a soft shadow.

31. A non-transitory computer-readable media storing computer instructions which when executed by one or more processors of a device cause the device to:
generate an initialized cone representative of a region of a scene, wherein the initialized cone is defined by a central ray and an initialized angle from the central ray;
trace the central ray to determine visibility information for the central ray;
based on the visibility information for the central ray, detect a closest silhouette boundary to the central ray by angle; and
output an indication of the central ray and an angle of the closest silhouette boundary to the central ray as parameters of a continuous visibility gradient.

32. The non-transitory computer-readable media of claim 31, wherein the parameters are output for forward rendering.
